(19) United States
(12) Patent Application Publication
(10) Pub. No.: US 2026/0170895 A1
(43) Pub. Date: Jun. 18, 2026

(54) COIN PROCESSING DEVICE

(71) Applicant: JAPAN CASH MACHINE CO., LTD., Osaka-shi. Osaka (JP)

(72) Inventor: Kazuya NISHIMURA, Osaka (JP)

(21) Appl. No.: 19/125,946

(22) PCT Filed: Aug. 31, 2023
(86) PCT No.: PCT/JP2023/031700

§ 371 Date: Apr. 30, 2025

(30) Foreign Application Priority Data
Nov. 4, 2022 (JP) 2022-177388

(51) Int. Cl. G07D 3/14

(52) U.S. Cl. CPC G07D 3/14

(57) ABSTRACT

Provided is a coin processing device which includes a handling section for receiving coins or medals and sending them out one by one, a sorting section for receiving the coins or medals one by one from the handling section, determining the type of the coin or medal while moving the coin or medal along an arc, and guiding the coin or medal to a path for each type, a common motor for providing driving force to the handling section and the sorting section, and a computer for controlling the motor. The computer causes the motor to rotate in the reverse direction when the sorting section has rotated a first predetermined amount while the handling section is stopped rotating.

### TECHNICAL FIELD

The present invention relates to a coin processing device for receiving coins or medals and sorting them by type.

### BACKGROUND ART

Conventionally, devices for receiving coins or medals and sorting them by type have been known. For example, JP-A-2018-147425 (PTL 1) discloses a coin processing device. According to PTL 1, the coin processing device includes a coin receiving section, an identifying section for identifying the coin, a guide section having a lower contact surface capable of abutting from below against the circumferential surface of the upright coin, a support section having an upright contact surface capable of abutting against either the front or back surface of the upright coin, and at least one coin passing hole formed in the upright contact surface, which supports the coin so that it is upright, an endless conveyor belt capable of clamping the coin in cooperation with the upright contact surface, a rotation drive section for rotating the conveyor belt, a shutter capable of opening and closing at least a part of the opening surface of the coin passing hole, and a shutter drive section for opening and closing the shutter.

### CITATION LIST

### Patent Literature

PTL 1: JP-A-2018-147425

### SUMMARY OF INVENTION

### Technical Problem

An object of the present invention is to provide a coin processing device that can normally perform sorting processing even when coins or medals are jammed.

### Solution to Problem

According to an aspect of the present invention, there is provided a coin processing device that includes a handling section for receiving coins or medals and sending them out one by one, a sorting section for receiving the coins or medals one by one from the handling section, determining the type of the coin or medal while moving the coin or medal along an arc, and guiding the coin or medal to a path for each type, a common motor for providing driving force to the handling section and the sorting section, and a computer for controlling the motor. The computer causes the motor to rotate in the reverse direction when the sorting section has rotated a first predetermined amount while the handling section is stopped rotating.

### Advantageous Effects of Invention

As described above, according to the present invention, a coin processing device is provided that can normally perform sorting processing even when coins or medals are jammed.

### BRIEF DESCRIPTION OF THE DRAWINGS

FIG. 1 is a conceptual diagram showing an entire coin processing device 100 according to First embodiment.

FIG. 2 is a side cross-sectional view showing the overall configuration of the coin processing device 100 according to the First embodiment.

FIG. 3 is a plan view showing a coin identifying and sorting section of the coin processing device 100 according to the First embodiment.

FIG. 4 is an overall front cross-sectional view of the coin processing device 100 showing the flow of coins when they are inserted according to the First embodiment.

FIG. 5 is an overall side cross-sectional view of the coin processing device 100 showing the flow of coins when they are inserted according to the First embodiment.

FIG. 6 is an overall front cross-sectional view of the coin processing device 100 showing the flow of coins when ejecting them according to the First embodiment.

FIG. 7 is an overall side cross-sectional view of the coin processing device 100 showing the flow of coins when ejecting them according to the First embodiment.

FIG. 8 is an upper perspective view showing the coin identifying and sorting section according to the First embodiment.

FIG. 9 is an upper perspective view showing the coin identifying and sorting section with the conveying rotor removed according to the First embodiment.

FIG. 10 is an upper perspective view showing the coin insertion section and the handling section according to the First embodiment.

FIG. 11 is an upper perspective view showing the handling section according to the First embodiment.

FIG. 12 is an upper perspective view of the coin identifying and sorting section showing the scraper according to the First embodiment.

FIG. 13 is a side cross-sectional view of the sorting section showing the scraper according to the First embodiment.

FIG. 14 is a plan view showing the transfer area from the handling section to the sorting section according to the First embodiment.

FIG. 15 is an upper perspective view showing the discharge section to the reject path in the sorting section according to the First embodiment.

FIG. 16 is an upper perspective view showing the discharge operation to the reject path in the sorting section according to the First embodiment.

FIG. 17 is an upper perspective view showing the operation of discharging coins to each type of conveying path in the sorting section according to the First embodiment.

FIG. 18 is a plan view of the coin identifying and sorting section according to the First embodiment.

FIG. 19 is a perspective view showing the transmission mechanism of driving force to the handling section and the sorting section according to the First embodiment.

FIG. 20 is the first perspective view showing the transmission mechanism of driving force when the handling section according to the First embodiment is jammed.

FIG. 21 is the second perspective view showing the transmission mechanism of driving force when the handling section according to the First embodiment is jammed.

FIG. 22 is a lower perspective view showing the configuration of the middle gear according to the First embodiment.

FIG. 23 is an upper perspective view showing the configuration of the lower gear according to the First embodiment.

FIG. 24 is a side view showing the transmission mechanism between the middle gear, the lower gear, and the handling drive shaft according to the First embodiment.

FIG. 25 is an upper perspective view showing the configuration of the guide pin according to the First embodiment.

### DESCRIPTION OF EMBODIMENTS

The following describes embodiments of the present invention with reference to the accompanying drawings. In the following description, the same components are denoted by the same reference numerals. Their names and functions are also the same. Accordingly, detailed descriptions thereof of such elements will not be repeated.

### First Embodiment

### Overall Configuration of Coin Processing Device 100

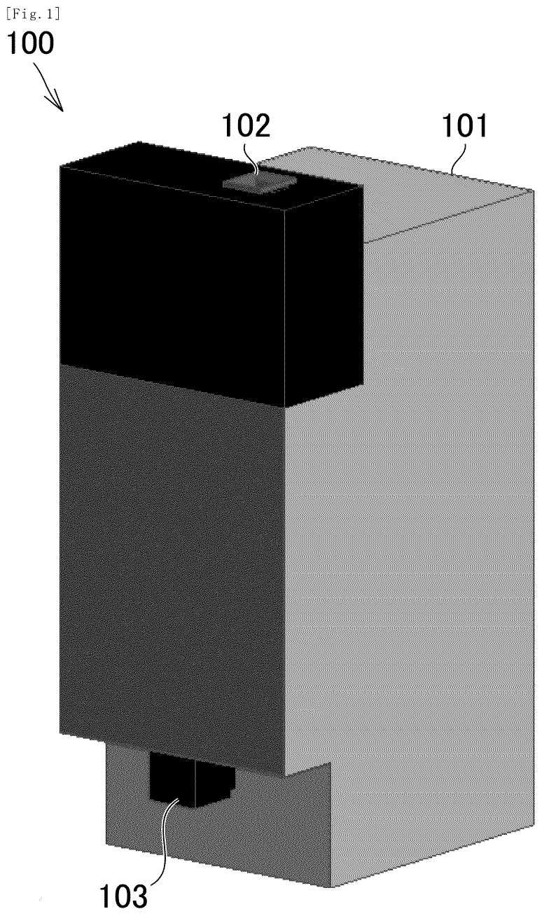

First, the overall configuration of a coin processing device 100 according to the present embodiment will be described. FIG. 1 is an external view of the coin processing device 100 according to the present embodiment. Referring to FIG. 1, the coin processing device 100 includes a substantially rectangular parallelepiped housing 101, with a coin insertion slot 102 provided at the top and a coin outlet 103 provided at the bottom.

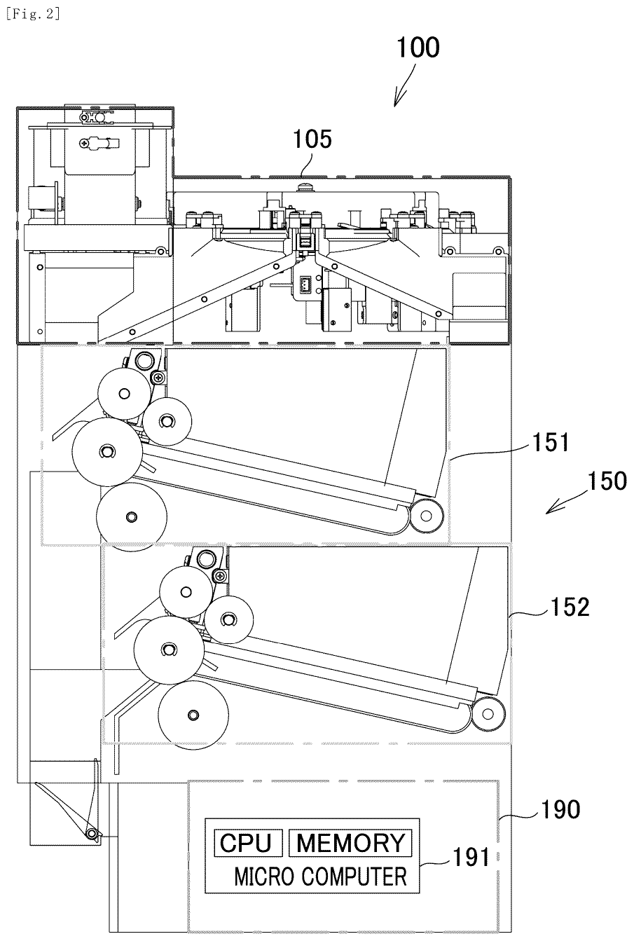

FIG. 2 is a side cross-sectional view showing the overall internal structure of the coin processing device 100 according to this embodiment. Referring to FIG. 2, the coin processing device 100 is provided with a coin identifying and sorting section 105 for sorting and sending out coins by type at its upper part, a coin dispensing section 150 for storing and dispensing coins by type at its middle part, and a control section 190 at its lower part. In this embodiment, the coin dispensing section 150 includes an upper dispensing section 151 for four denominations and a lower dispensing section 152 for four denominations. The control section 190 is provided with a microcomputer 191 for controlling each section of the coin processing device 100, other communication interfaces, and the like. The microcomputer 191 includes, for example, a CPU and various memories.

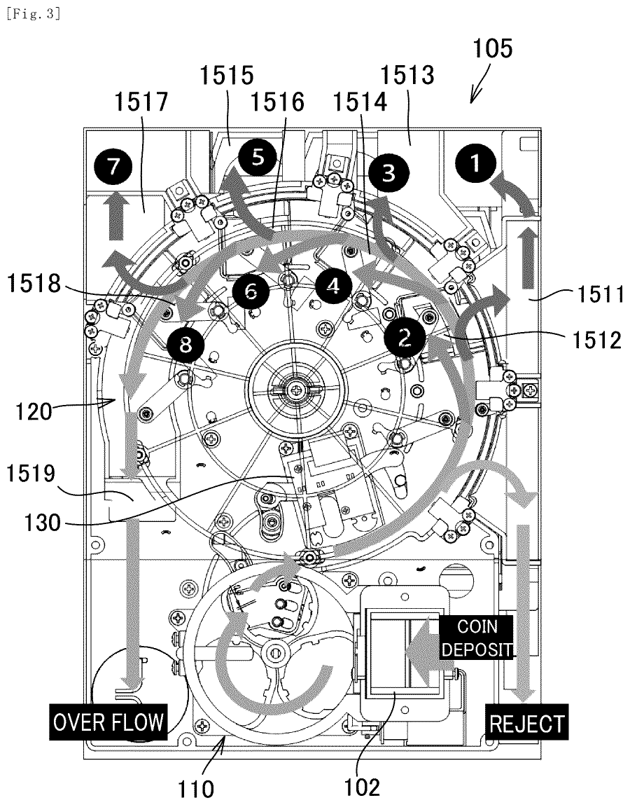

FIG. 3 is a plan view of the coin identifying and sorting section 105 according to this embodiment. Referring to FIG. 3, a plurality of inserted coins are sent one by one in turn the sorting section 120 by the handling section 110. The sorting section 120 identifies the type of coin for each coin and sends it to a reject conveying path 1510 formed outside the sorting section, a first conveying path 1511 formed outside the sorting section, a second conveying path 1512 formed inside the sorting section, a third conveying path 1513 formed outside the sorting section, a fourth conveying path 1514 formed inside the sorting section, a fifth conveying path 1515 formed outside the sorting section, a sixth conveying path 1516 formed inside the sorting section, a seventh conveying path 1517 formed outside the sorting section, an eighth conveying path 1518 formed inside the sorting section, or an overflow conveying path 1519 formed outside the sorting section.

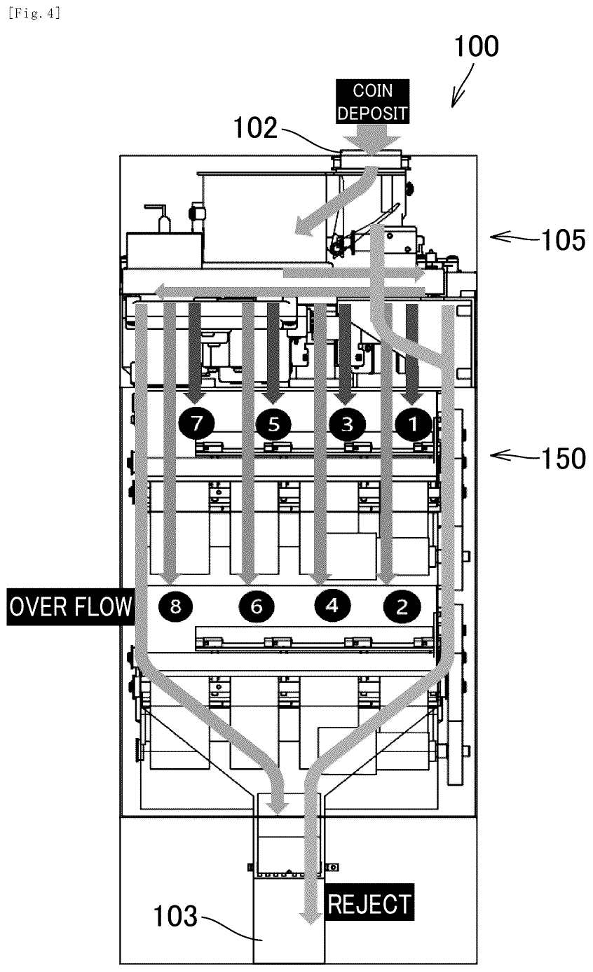

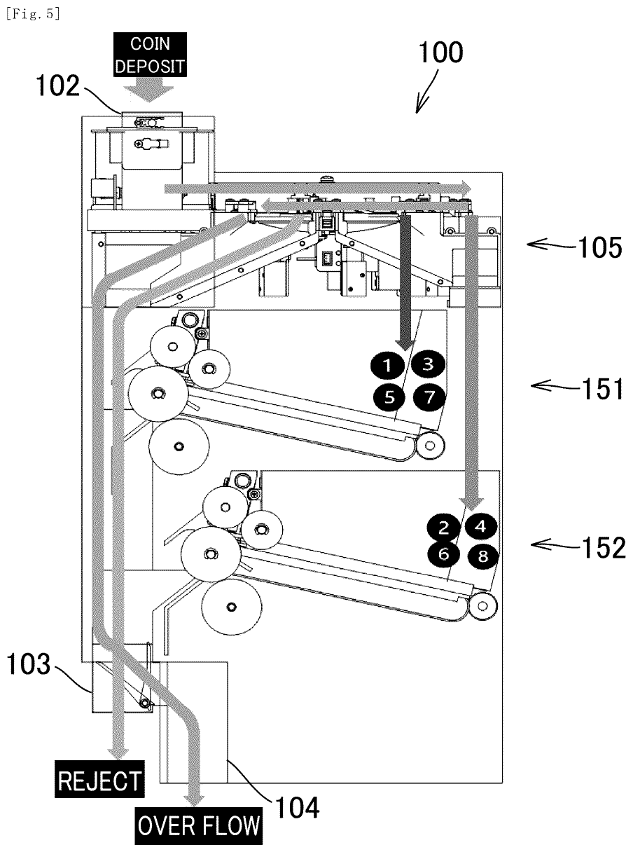

FIG. 4 is a front cross-sectional view showing the overall internal structure of the coin processing device 100 according to the present embodiment, and in particular, a flow when the inserted coins are sorted and stored. FIG. 5 is a side cross-sectional view showing the overall internal structure of the coin processing device 100 according to the present embodiment, and in particular, a flow when the inserted coins are sorted and stored. With reference to FIG. 4 and FIG. 5, a coin sent to the reject conveying path 1510 is moves downward at the right end in a front view, and at the front end in a side view, and is rejected from the coin outlet 103. A coin sent to the overflow conveying path 1519 is moves downward at the left end in a front view, and at the front end in a side view, and is sent to a container disposed below the coin processing device 100. Coins sent to the first conveying path 1511, the third conveying path 1513, the fifth conveying path 1515, and the seventh conveying path 1517 outside the sorting section 120 are accumulated in designated storage sections of the upper dispensing section 151 for each denomination. Coins sent to the second conveying path 1512, the fourth conveying path 1514, the sixth conveying path 1516, and the eighth conveying path 1518 inside the sorting section 120 are accumulated in designated storage sections of the lower dispensing section 152 by denomination.

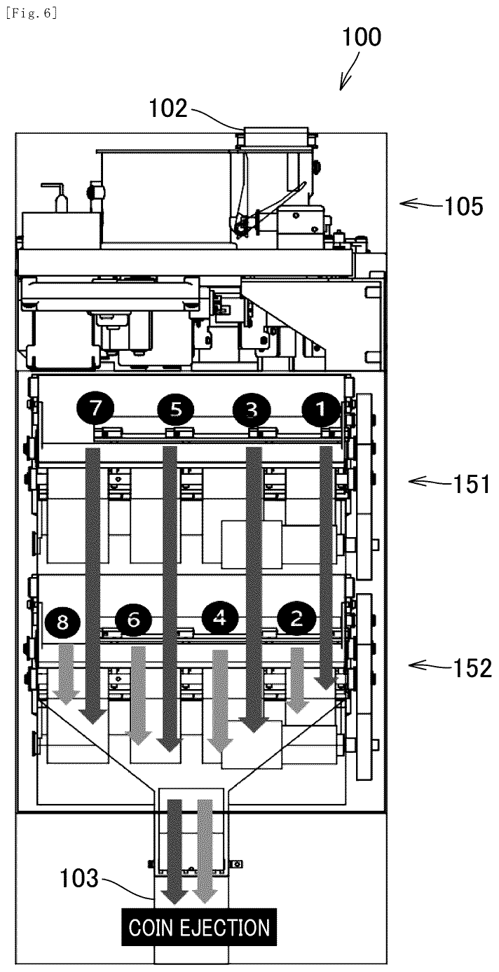

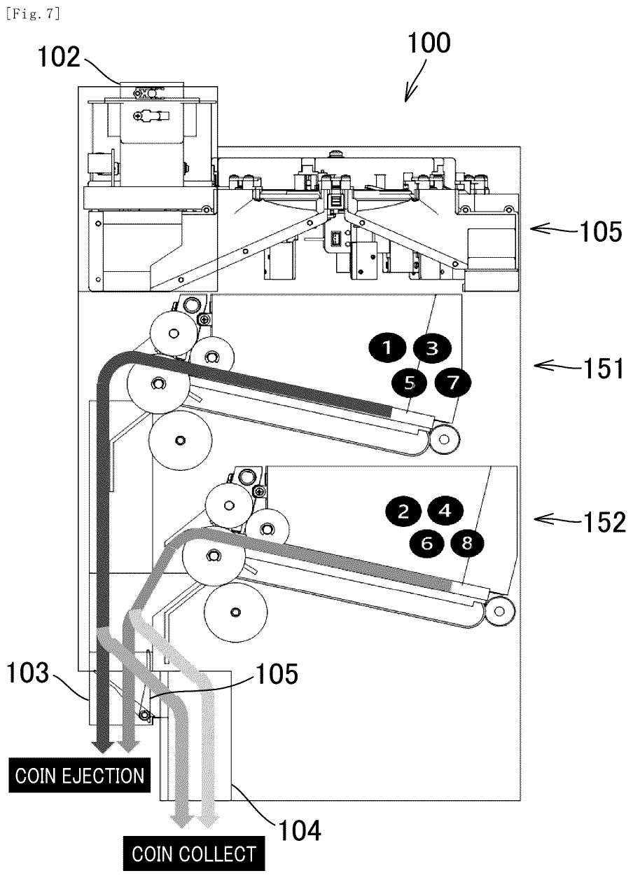

FIG. 6 is a front cross-sectional view showing the overall internal structure of the coin processing device 100 according to this embodiment, and in particular the flow when coins are dispensed or collected in a collection box (not shown). FIG. 7 is a side cross-sectional view showing the overall internal structure of the coin processing device 100 according to this embodiment, and in particular the flow when coins are dispensed or collected. With reference to FIG. 6 and FIG. 7, coins accumulated from the outside of the sorting section 120 via the first path, the third path, the fifth path, and the seventh path are sent forward through the upper dispensing section 151 and then lowered to be discharged from the coin outlet 103 or sent from the collection port 104 to the collection box in accordance with a command from the control section 190. Coins accumulated from the lower side of the sorting section 120 via the second path, the fourth path, the sixth path, and the eighth path are sent forward through the lower dispensing section 152 and then lowered to be discharged from the coin outlet 103 or sent from the collection port 104 to the collection box in accordance with a command from the control section 190.

### Configuration of Coin Identifying and Sorting Section 105

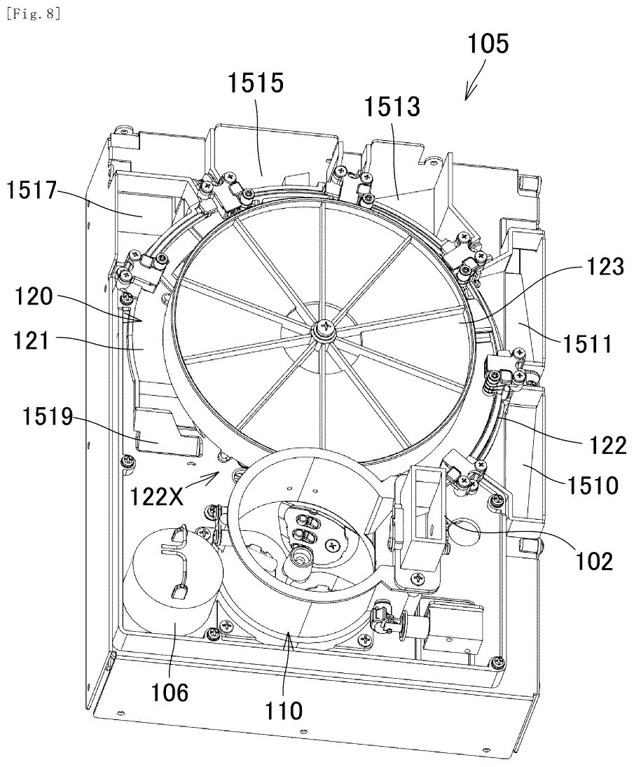

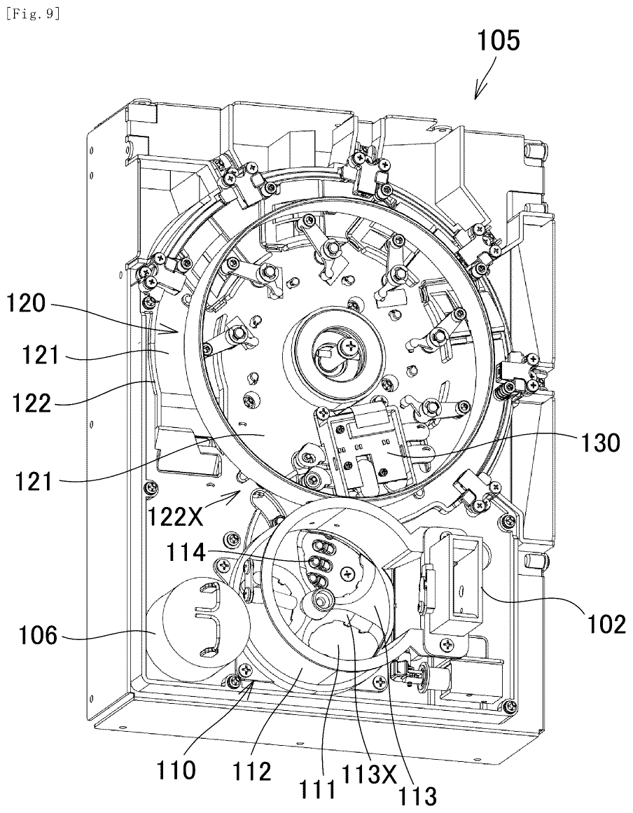

Next, the configuration of the coin identifying and sorting section 105 at the top of the coin processing device 100 will be described. With reference to FIG. 8 and FIG. 9, the coin identifying and sorting section 105 mainly includes a handling section 110 and a sorting section 120. The handling section 110 is disposed on the front side, i.e., the front part, of the coin processing device 100, and is for sending coins inserted one after another from the coin insertion slot 102 to the sorting section 120 one by one. The sorting section 120 is disposed on the back side, i.e., the rear part, of the coin processing device 100, and is for identifying the type of coin sent from the handling section 110 and sending it to the conveying path according to the type.

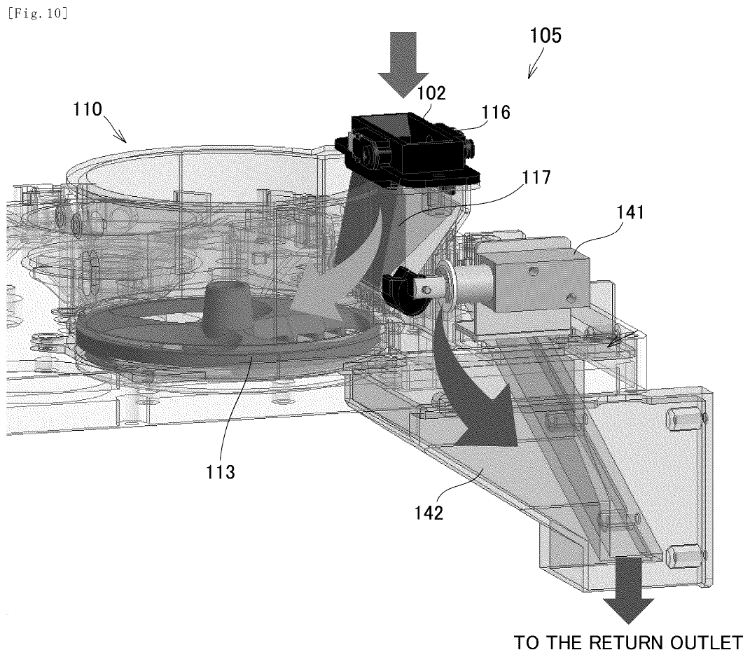

First, a brief description will be given of the mechanism before a coin is inserted into the handling section 110. Referring to FIG. 10, a detection sensor 116 is provided immediately below the coin insertion slot 102, and notifies the microcomputer 191 of the control section 190 of the insertion of a coin. A path switching flapper 117 and a solenoid 141 for opening and closing the flapper 117 are provided downstream of the detection sensor 116. When it is possible to accept coins, the microcomputer 191 controls the solenoid 141 to switch the flapper 117 so that the inserted coins flow to the handling section 110. On the other hand, when it is not possible to accept coins, the microcomputer 191 controls the solenoid 141 to switch the flapper 117 so that the inserted coins flow through the return duct 142 to the coin outlet 103.

### Configuration of the Handling Section 110

Next, the handling section 110 will be described. Returning to FIG. 8 and FIG. 9, the handling section 110 is provided with a circular base 111 and a cylindrical side wall 112. An intake turntable 113 is disposed on the upper surface of the base 111. A plurality of holes 113X into which coins fit are formed in the intake turntable 113. In this embodiment, three holes 113X are formed. That is, the holes 113X are formed at 120° intervals around the drive shaft. The intake turntable 113 is driven by a motor described later, and pushes the coins that fit into the holes 113X outward one by one from a discharge outlet 112X at the rear of the side wall 112, and sends them to the sorting section 120. More specifically, the coin rotates clockwise in a plan view in accordance with the movement of the hole 113X of the intake turntable 113, and when it hits the guide pins 114, 114, 114, it is pushed backward along the arrangement of the guide pins 114, 114, 114, i.e., to the outside of the side wall 112.

Here, a mechanism for sending coins one by one from the handling section 110 to the sorting section 120 will be described. That is, in the coin processing device 100 according to the present embodiment, even when multiple coins are piled up in one hole 113X and the coins start to be conveyed by the intake turntable 113, a mechanism is provided for outputting only one coin from one hole 113X through the discharge outlet 112X of the recess of the handling section 110.

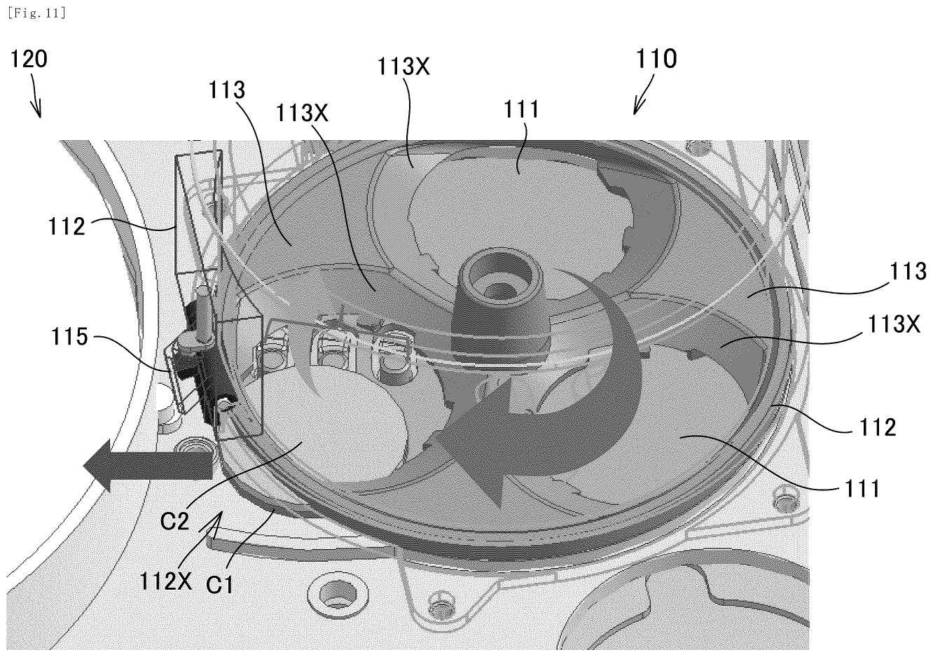

More specifically, as described above, when a coin that is caught in the hole 113X comes into contact with the guide pins 114, 114, 114, it is pushed by the intake turntable 113 and is output from the discharge outlet 112X of the side wall 112 along the arrangement of the guide pins 114, 114, 114. However, as shown in FIG. 11, when multiple coins are stored in the hole 113X in an overlapping state, multiple coins may be discharged from the discharge outlet 112X at the same time.

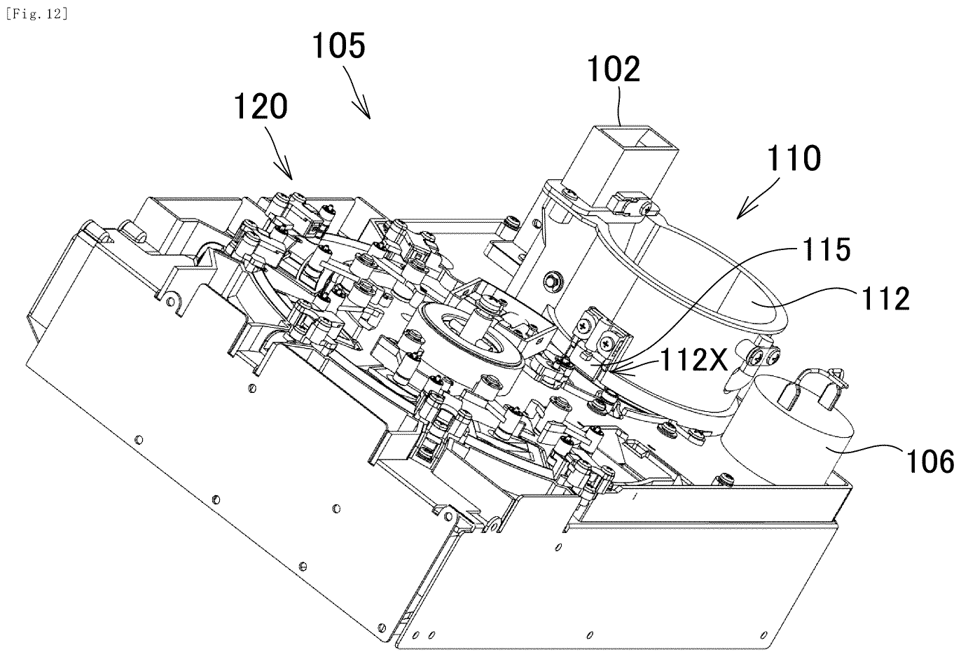

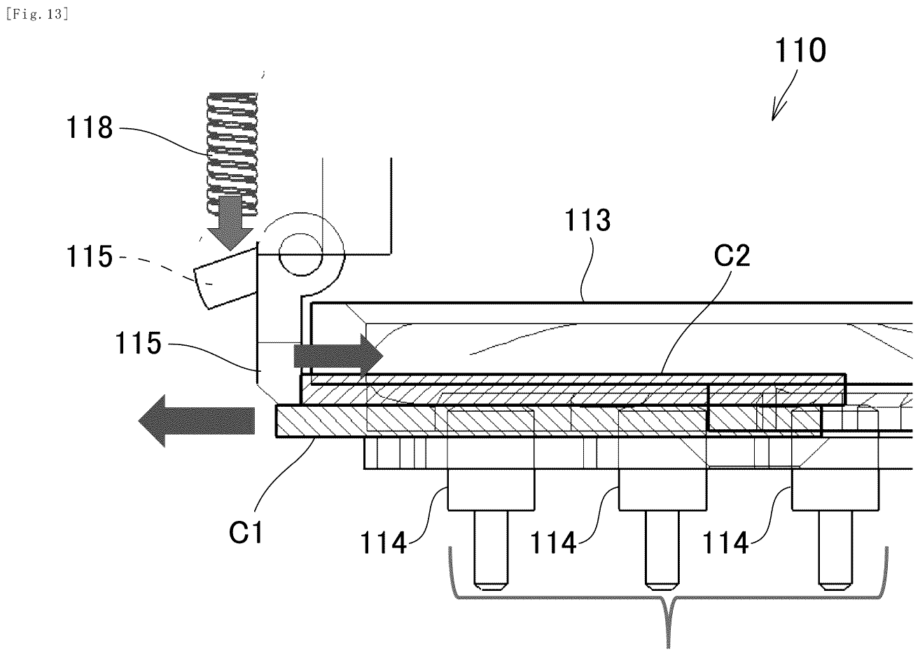

FIG. 12 and FIG. 13, in this embodiment, a scraper 115 for retaining the upper coin within the side wall 112 is attached to the discharge outlet 112X of the side wall 112. The scraper 115 is configured so as to be liftable clockwise in a side view around an upper part. The scraper 115 is biased by an urging member 118 in a direction to close downward. When the scraper 115 is in a state where it is closed downward, a gap of about 1 mm to 1.5 mm is generated between the lower end of the scraper 115 and the base 111.

In this embodiment, the height of the guide pins 114, 114, 114 protruding above the surface of the base 111 is set lower than the thinnest coin that the device targets. For example, it is set to about 1 mm. As a result, even if two thin coins are stacked in the hole 113X of the intake turntable 113, the lower coin Cl is pushed by the guide pins 114, 114, 114 and discharged from the gap under the scraper 115 to the outside of the side wall 112, i.e., to the sorting section 120.

Even if the lower coin Cl is thick, the coin Cl is pushed by the intake turntable 113 and is carried along the guide pins 114, 114, 114, pushing up the scraper 115, and is discharged from the discharge outlet 112X to the outside of the side wall 112, i.e., to the sorting section 120.

On the other hand, the upper coin C2 does not collide with the guide pin 114, but is pushed by the scraper 115 and toward the inside of the side wall 112.

Thus, in this embodiment, even if two coins are sent stacked on top of each other, only the upper coin C2 is blocked by the scraper 115 and moves above the guide pins 114, so that only the lower coin C1 is sent to the sorting section 120.

### Configuration of the Sorting Section 120

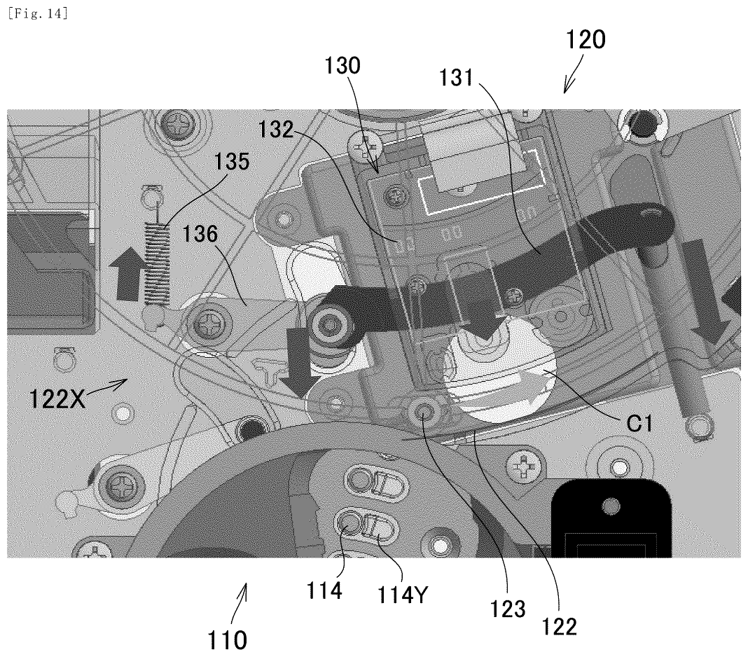

Next, the sorting section 120 will be described. With reference to FIGS. 8, 9, and 14, the sorting section 120 is provided with a circular base 121 and a side wall 122 provided on the outer periphery of the base 121. A conveying rotor 123 is disposed above the base 121. A plurality of conveying pins 123X, 123X . . . are formed on the conveying rotor 123 for pushing the coins forward from the rear. In this embodiment, five conveying pins 123X, 123X . . . are provided. That is, the conveying pins 123X, 123X . . . are attached at 72°intervals around the axis of the conveying rotor 123. The conveying rotor 123 is driven by the drive motor 106 to slide the coins one by one in the counterclockwise direction in a plan view along the passage between the side wall 122 and the conveying guide 131. That is, in this embodiment, the sorting section 120 can simultaneously carry a maximum of five coins and send them out onto the conveying path.

More specifically, the front end of the side wall 122 of the sorting section 120, i.e., the wall surface on the handling section 110 side, is opened to form a coin receiving part 122X. A coin received through the coin receiving part 122X is pushed by the conveying pin 123X and moves to the right between the side wall 122 and the conveying guide 131. That is, in a plan view, the coin moves around the circular base 121 in a counterclockwise direction.

An identification section 130 uses the magnetic sensor 132 and the like to determine whether the coins sent by the conveying pins 123X are genuine or counterfeit, and to identify the type of coin. The identification section 130 sends the determination results and identification results to the microcomputer 191 of the control section 190. In this embodiment, the memory of the microcomputer 191 stores the conveying path or the position of the storage case for each type of coin. Based on the determination results and identification results, the microcomputer 191 conveys the coin to a reject path, or to a conveying path or storage location according to the type.

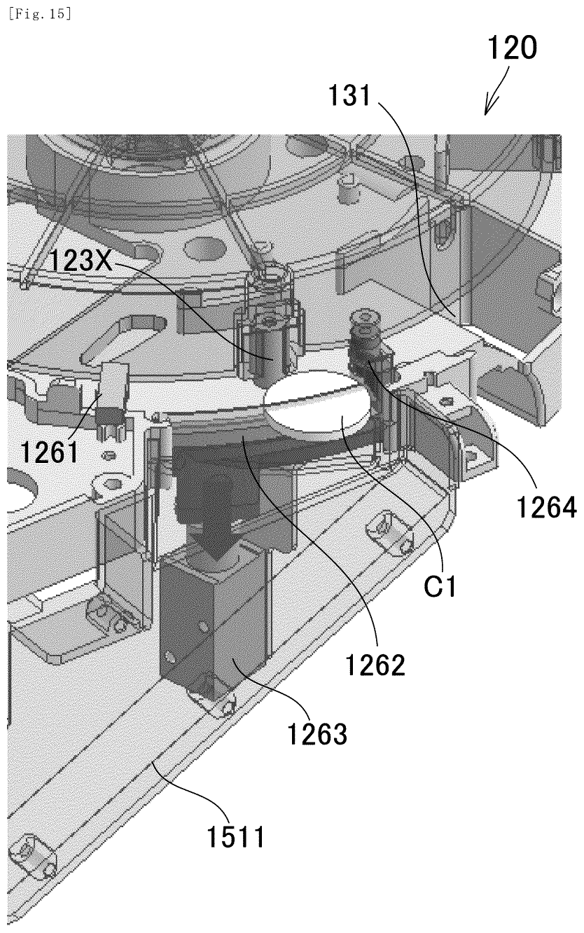

More specifically, when the microcomputer 191 recognizes through the identification section 130 that the coin is to be rejected, it opens the sorting gate 1262 for the reject path, as shown in FIG. 15, and sends the coin to the reject conveying path 1510.

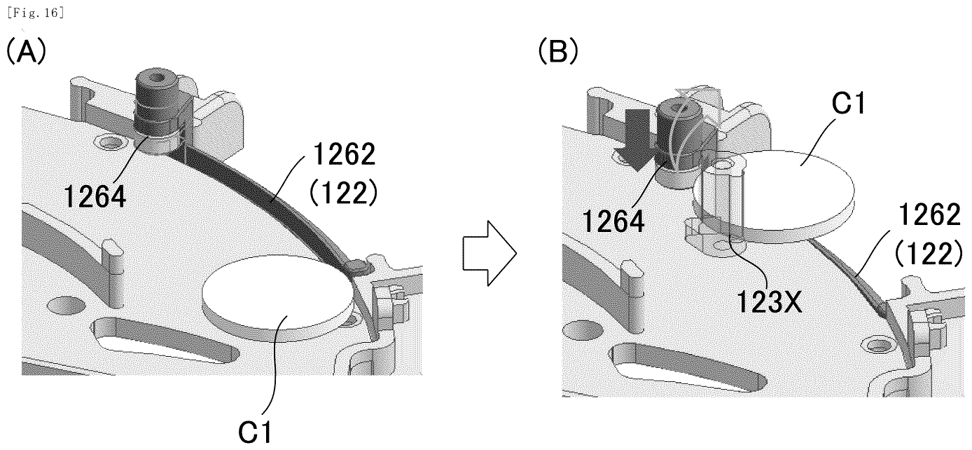

More specifically, as shown in FIG. 15 and FIG. 16(A), when a certain coin is determined by the identification section 130 to be rejected, the microcomputer 191 detects the passage of the coin by the timing sensor 1261. When the microcomputer 191 detects the passage of the coin, it controls the solenoid 1263 for the sorting gate 1262 to lower the sorting gate 1262. This opens a part of the side wall 122.

FIG. 15 and FIG. 16(B), the microcomputer 191 lowers the reject switching roller 1264 from the raised state to the base surface. As a result, the coin pushed by the conveying pin 123X is pressed against the switching roller 1264 and pushed outward. As a result, the coin flows down into the conveying path 1250 for reject.

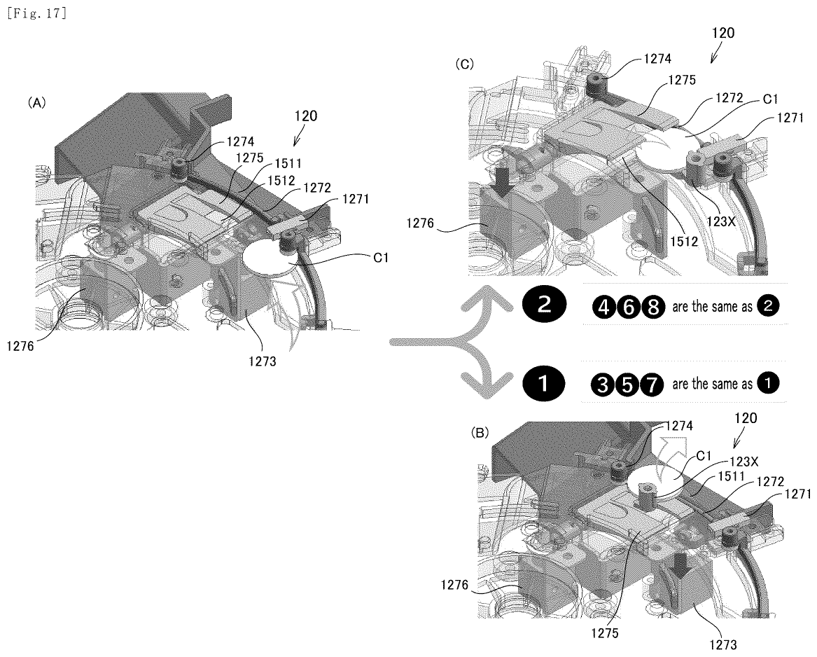

In this embodiment, as shown in FIG. 17(A), a sorting gate 1272 for sending the first type of coins to the conveying path 1511 outside the sorting section 120, and a sorting flap 1275 for sending the second type of coins to the conveying path 1512 below the sorting section 120 are provided downstream of the sorting gate 1262 for reject.

When the microcomputer 191 identifies a coin as the first or second type by the identification section 130, it detects the passage of the coin by way of the timing sensor 1271. When the microcomputer 191 detects the passage of the first type of coin, it controls the solenoid 1273 for the sorting gate 1272 to lower the sorting gate 1272, as shown in FIG. 17(B), i.e., the drawing at the lower right of FIG. 17. This opens a part of the side wall 122.

As shown in FIG. 17(B), the microcomputer 191 lowers the switching roller 1274 for the first type of coin from the raised state to the base surface. As a result, the coin pushed by the conveying pin 123X is pushed outward by being pressed against the switching roller 1274. As a result, the coin flows down into the conveying path 1511 for the first type of coin.

On the other hand, when the microcomputer 191 detects the passage of the second type of coin, as shown in FIG. 17(C), i.e., the drawing in the upper right of FIG. 17, it controls the solenoid 1276 for the sorting flap 1275 to lift the sorting flap 1275. This opens the bottom of the sorting flap 1275. This allows the second type of coin pushed by the conveying pin 123X to pass under the sorting flap 1275 and flow down into the conveying path 1512 for the second type provided below the sorting section 120.

In this embodiment, a sorting gate 1272 for sending the third type of coin to a conveying path outside the sorting section 120, and a sorting flap 1275 for sending the fourth type of coin to a conveying path below the sorting section 120, similar to that shown in FIG. 17(A), are provided downstream of the first type of sorting gate 1272.

More specifically, when the microcomputer 191 identifies a coin as the third or fourth type by the identification section 130, it detects the passage of the coin by the timing sensor 1271. When the microcomputer 191 detects the passage of the third type of coin, it controls the solenoid 1273 for the sorting gate 1272 to lower the sorting gate 1272, as shown in FIG. 17(B). This opens a part of the side wall 122.

As shown in FIG. 17(B), the microcomputer 191 lowers the switching roller 1274 for the third type of coin from above onto the base. As a result, the coin pushed by the conveying pin 123X is pushed outward by being pressed against the switching roller 1274. As a result, the coin flows down into the conveying path 1513 for the third type of coin.

On the other hand, when the microcomputer 191 detects the passage of the fourth type of coin, as shown in FIG. 17(C), it controls the solenoid 1276 for the sorting flap 1275 to lift the sorting flap 1275. This opens the bottom of the sorting flap 1275. This allows the fourth type of coin pushed by the conveying pin 123X to pass under the sorting flap 1275 and flow down into the conveying path 1514 for the fourth type below the sorting section 120.

In this embodiment, a sorting gate 1272 for sending the fifth type of coins to a conveying path outside the sorting section 120, and a sorting flap 1275 for sending the sixth type of coins to a conveying path below the sorting section 120, similar to that shown in FIG. 17(A), are provided downstream of the third type of sorting gate 1272.

When the microcomputer 191 identifies a coin as being of the fifth or sixth type by the identification section 130, it detects the passage of the coin by the timing sensor 1271. When the microcomputer 191 detects the passage of the fifth type of coin, it controls the solenoid 1273 for the sorting gate 1272 to lower the sorting gate 1272, as shown in FIG. 17(B). This opens a part of the side wall 122.

As shown in FIG. 17(B), the microcomputer 191 lowers the switching roller 1274 for the fifth type of coin from above onto the base. As a result, the coin pushed by the conveying pin 123X is pushed outward by being pressed against the switching roller 1274. As a result, the coin flows down into the conveying path 1515 for the fifth type of coin.

On the other hand, when the microcomputer 191 detects the passage of the sixth type of coin, as shown in FIG. 17(C), it controls the solenoid 1276 for the sorting flap 1275 to lift the sorting flap 1275. This opens the bottom of the sorting flap 1275. This allows the sixth type of coin pushed by the conveying pin 123X to pass under the sorting flap 1275 and flow down into the conveying path 1516 for the sixth type below the sorting section 120.

In this embodiment, a sorting gate 1272 for sending the seventh type of coin to a conveying path outside the sorting section 120, and a sorting flap 1275 for sending the eighth type of coin to a conveying path below the sorting section 120, similar to that shown in FIG. 17(A), are provided downstream of the fifth type of sorting gate 1272.

When the microcomputer 191 identifies a coin as being of the seventh or eighth type by the identification section 130, it detects the passage of the coin by the timing sensor 1271. When the microcomputer 191 detects the passage of the seventh type of coin, it controls the solenoid 1273 for the sorting gate 1272 to lower the sorting gate 1272, as shown in FIG. 17(B). This opens a part of the side wall 122.

As shown in FIG. 17(B), the microcomputer 191 lowers the switching roller 1274 for the third type of coin from above onto the base. As a result, the coin pushed by the conveying pin 123X is pushed outward by being pressed against the switching roller 1274. As a result, the coin flows down into the conveying path 1517 for the seventh type of coin.

On the other hand, when the microcomputer 191 detects the passage of the eighth type of coin, it controls the solenoid 1276 for the sorting flap 1275 to lift the sorting flap 1275, as shown in FIG. 17(C). This opens the bottom of the sorting flap 1275. This allows the eighth type of coin pushed by the conveying pin 123X to pass under the sorting flap 1275 and flow down into the conveying path 1518 for the eighth type below the sorting section 120.

As described above, the coin processing device 100 in this embodiment carries four types of coins toward the outside of the circular sorting section and carries four types of coins toward the bottom, making it possible to sort multiple types of coins more compactly than conventional devices.

In this embodiment, when the coin storage case of the coin dispensing section 150 becomes full, the microcomputer 191 keeps all sorting gates 1272 and sorting flaps 1275 closed, so that coins that have made almost one full revolution around the sorting section 120 are dropped into the overflow conveying path 1519, as shown in FIG. 3.

### Driving Mechanism of the Handling Section 110 and the Sorting Section 120

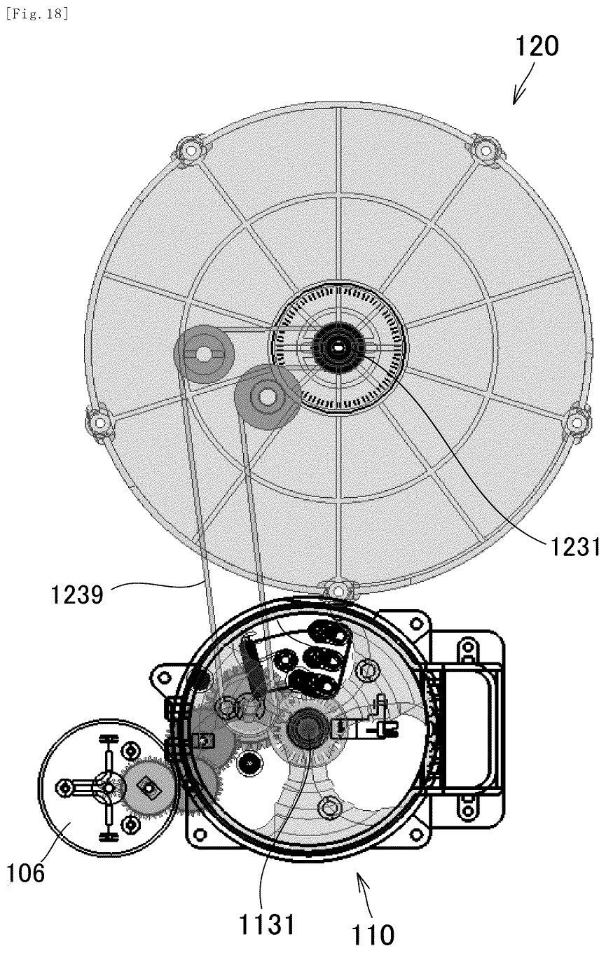

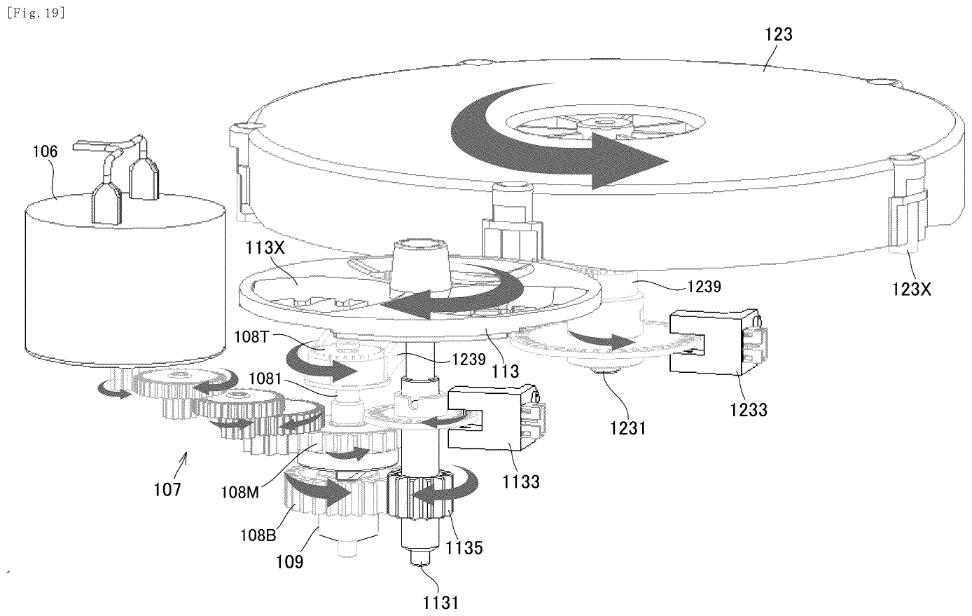

Next, the drive mechanism of the handling section 110 and the sorting section 120 will be described. As shown in FIG. 18 and FIG. 19, the driving force of the drive motor 106 is transmitted to the handling drive shaft 1131 of the intake turntable 113 of the handling section 110 through a gear group 107 including plurality of gears, i.e., a gear reduction section. In this embodiment, the driving force of the drive motor 106 is also provided to the conveying rotor between the gear group 107 and the handling drive shaft 1131. More specifically, the driving force of the drive motor 106 is also transmitted to the sorting drive shaft 1231 of the conveying rotor 123 through the upper pulley 108T having the same axis as the common shaft 1081 of the middle gear 108M arranged at the rear end of the gear group 107 and the belt 1239.

That is, in this embodiment, the driving force of one drive motor 106 is used to drive the intake turntable 113 of the handling section 110 and the conveying rotor 123 of the sorting section 120 simultaneously.

Especially, in this embodiment, the timing at which coins are sent out by the rotation of the intake turntable 113 of the handling section 110 corresponds to the timing at which the conveying pins 123X of the conveying rotor 123 of the sorting section 120 start to carry coins. As described above, the intake turntable 113 of the handling section 110 has three holes 113X, 113X, and 113X, and the conveying rotor 123 of the sorting section 120 has five conveying pins 123X, 123X, 123X, 123X, and 123X. Therefore, the number of teeth of the middle gear 108M and lower gear 108B of the common shaft 1081, the diameter of the upper pulley 108T, the number of teeth of the gear 1135 of the handling drive shaft 1131, and the diameter of the pulley of the sorting drive shaft 1231 are designed so that the conveying rotor 123 of the sorting section 120 rotates 72° while the intake turntable 113 of the handling section 110 rotates 120°.

In this way, in the coin processing device 100 according to this embodiment, coins inserted through the coin insertion slot 102 are separated one by one by the handling section 110 and sent to the sorting section 120. The three holes 113X, 113X, 113X of the intake turntable 113, and the five conveying pins 123X, 123X, 123X, 123X, 123X of the conveying rotor 123 of the sorting section 120 are synchronized with each other, and the structure is such that coins are always handed over at the same timing. The coins sent to the sorting section 120 are then judged by the identification section 130 as to whether they are genuine or counterfeit, their denominations, etc., and are conveyed to the respective conveying paths based on the results.

### Mechanism for Clearing Jams

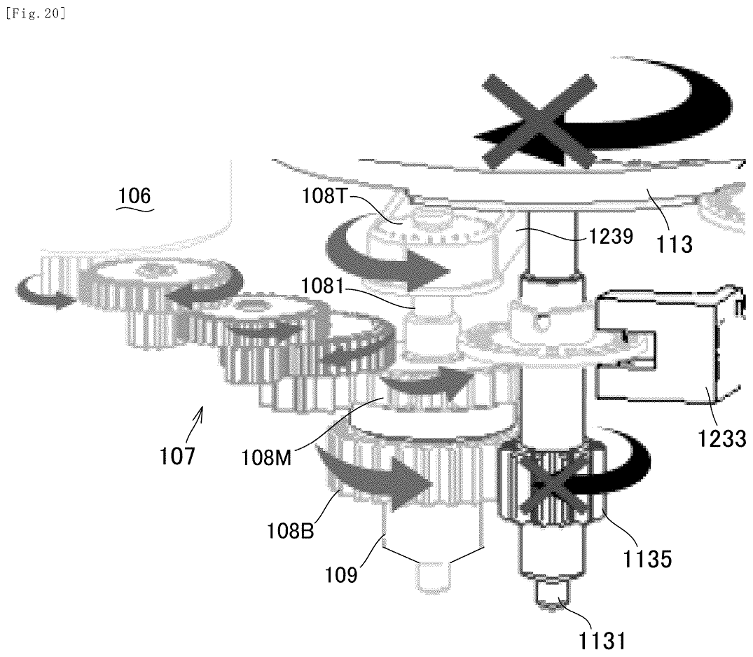

The following describes a mechanism for restoring the intake turntable 113 of the handling section 110 when it stops due to a coin jam or the like. In this embodiment, as shown in FIG. 20, when the intake turntable 113 stops, the common shaft 1081 and the sorting section 120 continue to drive for a certain period of time with the transmission to the handling drive shaft 1131 released.

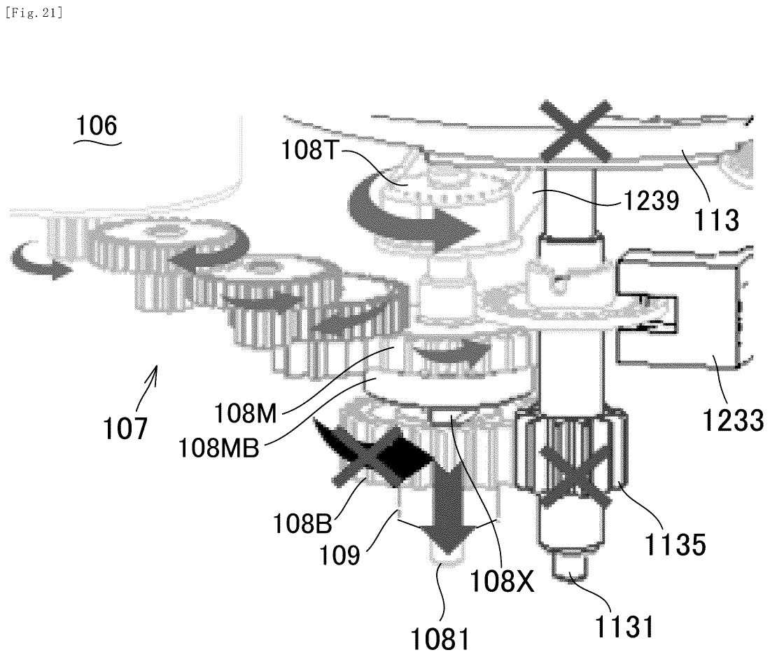

More specifically, in this embodiment, when the handling section 110 becomes clogged, as shown in FIG. 21, the driving force of the drive motor 106 is transmitted to the middle gear 108M, the upper pulley 108T, and the sorting section 120, but the transmission of the driving force to the lower gear 108B and the handling drive shaft 1131 is cut off.

More specifically, referring to FIG. 19 and FIG. 21, a middle gear 108M for receiving a driving force from the gear group 107 is provided at the middle of the common shaft 1081. An upper pulley 108T is provided at the upper part of the common shaft 1081. A lower gear 108B is provided at the lower part of the common shaft 1081. The lower gear 108B is biased upward by a push spring 109.

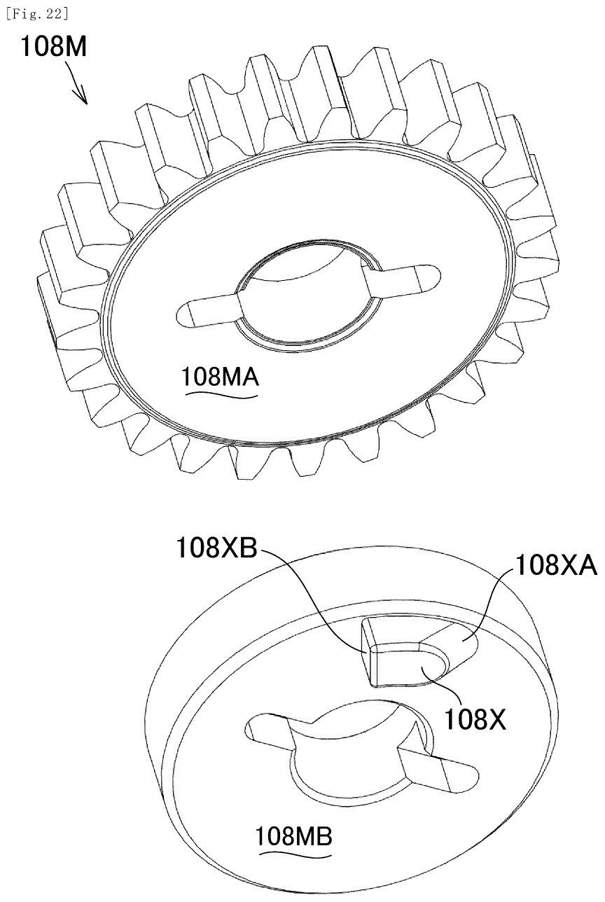

In this embodiment, as shown in FIG. 22, the middle gear 108M is composed of a gear section 108MA that rotates integrally with the common shaft 1081, and a clutch section 108MB with a convex section 108X formed on its underside. These may be assembled by fixing two members together, or may be integrally molded, as long as they rotate integrally. The convex section 108X is formed with an inclined section 108XA that comes into contact with and slides on an inclined section 108YA of the lower gear 108B, which will be described later, and an upright section 108XB that comes into contact with an upright section 108YB of the lower gear 108B, which will be described later.

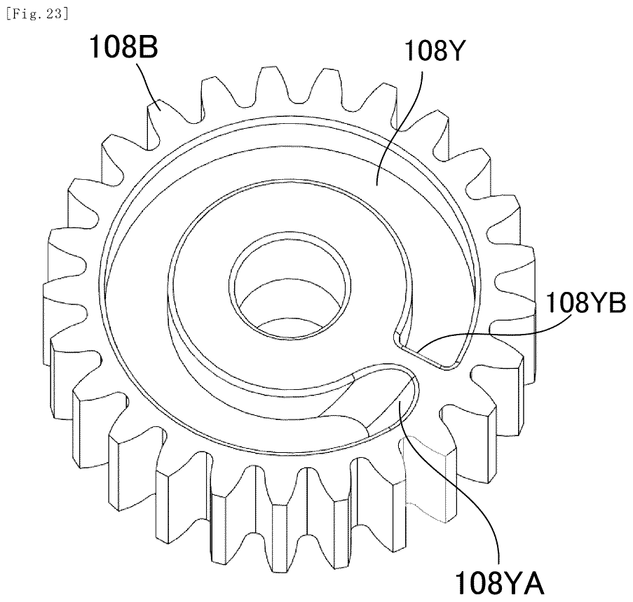

As shown in FIG. 23, the lower gear 108B has a groove section 108Y formed on its upper surface capable of accommodating the convex section 108X of the middle gear 108M. A slanted section 108YA facing the inclined section 108XA of the convex section 108X and an upright section 108YB facing the upright section 108XB are formed in a part of the groove 108Y. The lower gear 108B is pivotally supported on the common shaft 1081 so as to be rotatable idly, and is configured to engage with the clutch section 108MB of the middle gear 108M by a push spring 109.

Normally, the force of the push spring 109 causes the convex section 108X of the middle gear 108M to fit into the groove section 108Y of the lower gear 108B, and with the inclined section 108XA of the middle gear 108M in contact with the inclined section 108YA of the lower gear 108B, the driving force transmitted to the middle gear 108M is transmitted to the lower gear 108B, and as a result, the handling drive shaft 1131 is driven via the handling gear 1135.

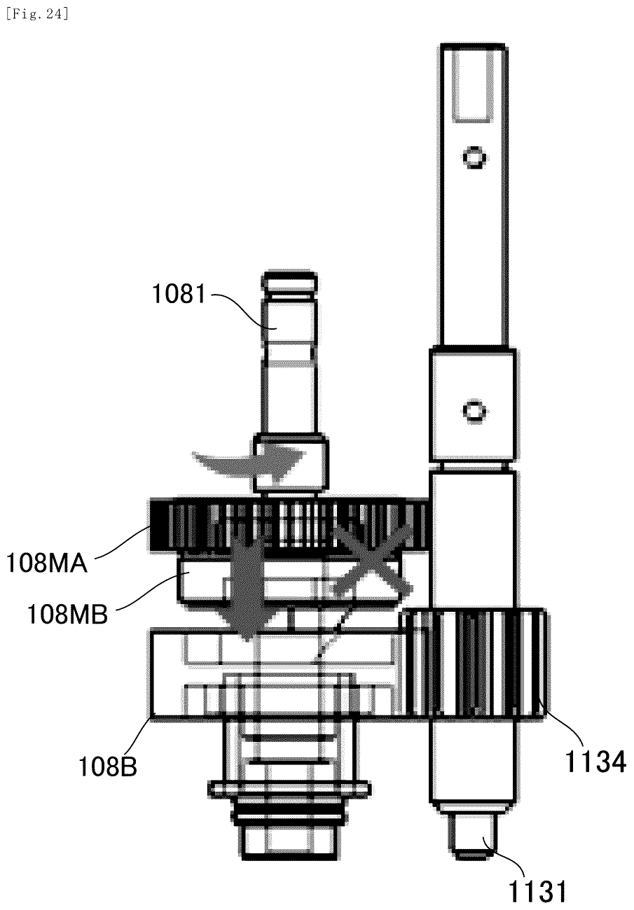

However, if the sorting section 120, the intake turntable 113, or the handling drive shaft 1131 stops, for example, when a coin gets caught in the intake turntable 113, as shown in FIG. 24, the inclined section 108XA of the convex section 108X of the clutch section 108MB of the middle gear 108M presses the inclined section 108YA of the lower gear 108B, thereby pushing the lower gear 108B downward against the biasing force of the push spring 109. In other words, the convex section 108X of the middle gear 108M climbs over the inclined section 108YA of the lower gear 108B.

After climbing over the inclined section 108YA, the convex section 108X of the middle gear 108M moves inside the groove section 108Y of the lower gear 108B without resistance. That is, until the convex section 108X reaches the inclined section 108YA again, the middle gear 108M and the common shaft 1081 can rotate idly relative to the lower gear 108B. That is, while the handling section 110 is stopped, the common shaft 1081, the upper pulley 108T, and the sorting section 120 are driven.

More specifically, in this embodiment, as described above, the intake turntable 113 and the conveying rotator 123 are configured to be synchronized and deliver coins one by one. Therefore, in this embodiment, a step clutch gear including a lower gear 108B and a middle gear 108M is provided on the common shaft 1081 which is the branch point of the handling section 110 and the sorting section 120. As a result, when a load of a certain level or more is applied due to the stopping of the intake turntable 113, the step clutch is automatically disengaged, and only the conveying rotator 123 can be driven with the drive to the intake turntable 113 cut off.

As shown in FIG. 19, in this embodiment, a handling sensor 1133 is provided for detecting the rotation of a handling drive shaft 1131 which is the drive shaft of the intake turntable 113, and a sorting sensor 1233 is provided for detecting the rotation of a sorting drive shaft 1231 which is the drive shaft of the conveying rotator 123. This allows the microcomputer 191 in this embodiment to detect, via the handling sensor 1133, whether the intake turntable 113 is rotating forward, has stopped, or has rotated in a reverse direction. Also, the microcomputer 191 can detect, via the sorting sensor 1233, whether the conveying rotator 123 is rotating forward, has stopped, or has rotated in a reverse direction.

In this embodiment, when the microcomputer 191 detects via the sorting sensor 1233 that the sorting section 120 has rotated a predetermined amount or for a predetermined time from the timing at which it detects via the handling sensor 1133 that the handling section 110 has stopped, it is programmed to determine that all of the coins in the sorting section 120 have been sorted, and to reverse the drive motor 106 to perform an inversion operation of the handling section 110 and the sorting section 120.

For example, the microcomputer 191 detects via the handling sensor 1133 that the handling drive shaft 1131 has stopped, and then, upon confirming via the sorting sensor 1233 that the sorting drive shaft 1231 has rotated a predetermined angle, such as 300°, causes the drive motor 106 to rotate in the reverse direction.

In other words, in this embodiment, the number of teeth of the various gears of the common shaft 1081, the diameter of the upper pulley 108T, the diameter of the pulley of the sorting drive shaft 1231, etc. are designed so that the sorting drive shaft 1231 can rotate at least a predetermined angle, for example 300°, between the time when the convex section 108X overcomes the inclined section 108YA and the time when it reaches the inclined section 108YA again.

In addition, when the drive motor 106 rotates in reverse, the biasing force of the push spring 109 causes the convex section 108X of the middle gear 108M to fit into the groove section 108Y of the lower gear 108B. After the middle gear 108M rotates in the reverse direction a predetermined amount, the upright section 108XB of the middle gear 108M abuts the upright section 108YB of the lower gear 108B, and the driving force transmitted to the middle gear 108M is transmitted to the lower gear 108B. As a result, the handling drive shaft 1131 is driven in the reverse direction via the handling gear 1135 together with the sorting drive shaft 1231.

Thereafter, when the microcomputer 191 detects via the handling sensor 1133 that the handling drive shaft 1131 has reversed a predetermined angle, for example, 360°, the microcomputer 191 is programmed to rotate the drive motor 106 in the forward direction again. Even during forward rotation, the convex section 108X of the middle gear 108M is inserted into the groove section 108Y of the lower gear 108B by the biasing force of the push spring 109, and after the middle gear 108M has rotated a predetermined amount, the driving force transmitted to the middle gear 108M is transmitted to the lower gear 108B in a state in which the inclined section 108XA of the middle gear 108M abuts against the inclined section 108YA of the lower gear 108B. As a result, the handling drive shaft 1131 is driven in the forward direction via the handling gear 1135 together with the sorting drive shaft 1231.

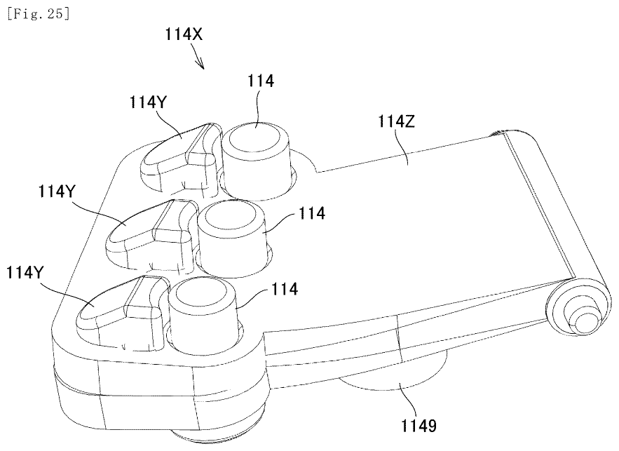

In this embodiment, the guide pins 114, 114, 114 are provided downstream of the discharge outlet 112X. More specifically, as shown in FIG. 25, the guide pins 114, 114, 114 are provided downstream of the guide member 114X. Then, inclined sections 114Y, 114Y, 114Y are formed on the guide member 114X downstream of the guide pins 114, 114, 114. Then, the guide member 114X is configured to be movable in the up-down direction by having an upstream end of its base section 114Z pivotally supported, and is biased upward by a push spring 1149.

As a result, when a coin enters the hole 113X and flows in, the coin collides with the vertical side surfaces of the guide pins 114, 114, 114, and is guided toward the discharge outlet 112X.

The intake turntable 113 is held in a raised position slightly higher than the amount of projection of the guide pins 114.

As described above, when the intake turntable 113 is turned over, the coins and the intake turntable 113 come into contact with the inclined sections 114Y, 114Y, 114Y, and push the guide member 114X downward, thereby enabling the intake turntable 113 to be turned over smoothly.

### Second Embodiment

In the above embodiment, four types of coins are sent out to the outside of the sorting section 120 via the four sorting gates 1272, and conveying paths for the four types of coins are provided below the sorting section 120 via the four sorting flaps 1275. However, the number of gates and the number of outer conveying paths are not limited, and the number of flaps and the number of lower conveying paths are also not limited.

In addition, a conveying path may be provided only on the outside of the sorting section 120 by providing only one or more gates, or a conveying path may be provided only below the sorting section 120 by providing only one or more flaps.

### Third Embodiment

In the above embodiment, the intake turntable 113 of the handling section 110 and the conveying rotor 123 of the sorting section 120 are driven and reversed by a single drive motor 106. However, the intake turntable 113 of the handling section 110 and the conveying rotor 123 of the sorting section 120 may be driven by separate motors. Then, the microcomputer 191 may drive and reverse these motors based on the detection results of the handling sensor 1133 and the sorting sensor 1233.

In this embodiment, when a coin becomes jammed in the handling section 110, the microcomputer 191 can reverse or rotate only the handling section 110 in the normal direction while rotating only the sorting section 120 in the normal direction.

### Fourth Embodiment

In the above embodiment, the coin processing device 100 processes coins, but the objects to be sorted are not limited to coins having monetary value, and may be medals used in games, etc. Or the coin processing device 100 may recognize or sort other circular metal types, or determine the authenticity of them.

### Review

In the above embodiment, a coin processing device is provided that includes a handling section for receiving coins or medals and sending them out one by one, a sorting section for receiving the coins or medals one by one from the handling section, determining the type of the coin or medal while moving the coin or medal along an arc, and guiding the coin or medal to a path for each type, a common motor for providing driving force to the handling section and the sorting section, and a computer for controlling the motor. The computer causes the motor to rotate in the reverse direction when the sorting section has rotated a first predetermined amount while the handling section is stopped rotating.

Preferably, the first predetermined amount is an amount sufficient for all of the coins or medals in the sorting section to be guided to the path for each type.

Preferably, the coin processing device further includes a first sensor for detecting the rotation of the handling section, and a second sensor for detecting the rotation of the sorting section. The computer uses the first sensor and the second sensor to recognize that the sorting section has rotated the first predetermined amount while the handling section is stopped rotating.

Preferably, the coin processing device further includes a gear that is arranged on a transmission path of a driving force from the motor to a rotating shaft of the handling section, and that rotates freely a predetermined angle corresponding to the first predetermined amount when a load is applied to the rotating shaft.

It should be considered that the embodiments disclosed this time are illustrative in all respects and not restrictive. The scope of the present invention is indicated by the scope of the claims rather than the above description, and is intended to include all modifications within the scope and meaning equivalent to the scope of the claims.

### REFERENCE SIGNS LIST

100: Coin processing device
101: Housing
102: Coin insertion slot
103: Coin outlet
104: Collection port
105: Coin identifying and sorting section
106: Drive motor
107: Gear group
108M: Middle gear
108MA: Gear section
108MB: Clutch section
108X: Convex section
108XA: Inclined section
108XB: Upright section
108B: Lower gear
108Y: Groove section
108YA: Inclined section
108YB: Upright section
108T: Upper pulley
109: Push spring
110: Handling section
111: Base
112: Side wall
112X: Discharge outlet
113: Intake turntable
113X: Coin holding hole
114: Guide pin
114X: Guide member
114Y: Inclined section
114Z: Guide base
115: Scraper
116: Detection sensor
117: Path switching flapper
118: Urging member
120: Sorting section
121: Base
122: Side wall
122X: Coin receiving part
123: Conveying rotor
123X: Conveying pin
130: Identification section
131: Conveying guide
132: Magnetic sensor
141: Solenoid
142: Return duct
150: Coin dispensing section
151: Upper dispensing section
152: Lower dispensing section
190: Control section
191: Microcomputer
1081: Common shaft
1131: Handling drive shaft
1133: Handling sensor
1135: Handling gear
1149: Push spring
1231: Sorting drive shaft
1233: Sorting sensor
1239: Belt
1250: Conveying path
1261: Timing sensor
1262: Sorting gate
1263: Solenoid
1264: Switching roller
1271: Timing sensor
1272: Sorting gate
1273: Solenoid
1274: Switching roller
1275: Sorting flap
1276: Solenoid
1510: Reject conveying path
1511: First conveying path
1512: Second conveying path
1513: Third conveying path
1514: Fourth conveying path
1515: Fifth conveying path
1516: Sixth conveying path
1517: Seventh conveying path
1518: Eighth conveying path
1519: Overflow conveying path
C1: Coin
C2: Coin

What is claimed is:

1. A coin processing device comprising:
a handling section for receiving coins or medals and sending them out one by one;
a sorting section for receiving the coins or medals one by one from the handling section, determining the type of the coin or medal while moving the coin or medal along an arc, and guiding the coin or medal to a path for each type;
a common motor for providing driving force to the handling section and the sorting section; and
a computer for controlling the motor,
wherein the computer causes the motor to rotate in the reverse direction when the sorting section has rotated a first predetermined amount while the handling section is stopped rotating.

2. The coin processing device according to claim 1, wherein the first predetermined amount is an amount sufficient for all of the coins or medals in the sorting section to be guided to the path for each type.

3. The coin processing device according to claim 1 or 2, further comprising a first sensor for detecting the rotation of the handling section, and a second sensor for detecting the rotation of the sorting section,
wherein the computer uses the first sensor and the second sensor to recognize that the sorting section has rotated the first predetermined amount while the handling section is stopped rotating.

4. The coin processing device according to any one of claims 1 to 3, further comprising a gear that is arranged on a transmission path of a driving force from the motor to a rotating shaft of the handling section, and that rotates freely a predetermined angle corresponding to the first predetermined amount when a load is applied to the rotating shaft.
